(19) United States
(12) Patent Application Publication
(10) Pub. No.: US 2022/0304325 A1
(43) Pub. Date: Sep. 29, 2022

(54) EMULSION FOR MODULATING SENSORY PROPERTIES IN FOODS AND BEVERAGES

(71) Applicant: Firmenich SA, Satigny (CH)

(72) Inventors: Alan Parker, Satigny (CH); Jean-Luc Gelin, Satigny (CH)

(21) Appl. No.: 17/059,355

(22) PCT Filed: Oct. 15, 2019
(86) PCT No.: PCT/EP2019/077930

§ 371 Date: Nov. 27, 2020

(30) Foreign Application Priority Data
Oct. 17, 2018 (EP) 18200912.6

(51) Int. Cl. A23D 7/01; A23D 7/005; A23C 9/152; A23C 9/13; A23L 27/00

(52) U.S. Cl. CPC A23D 7/011; A23D 7/0053; A23C 9/1528; A23C 9/1315; A23L 27/80; A23V 2002/00

(57) ABSTRACT

Described herein is a food grade emulsion capable of modulating sensory properties in foods and beverages. The emulsion is characterized by the presence in its dispersed phase of at least one enzymatically modified lipid component. The emulsion constitutes a stable and effective flavour delivery system and can thus be incorporated as such in a food composition or a beverage composition.

### TECHNICAL FIELD

The present invention relates to the flavour industry. It concerns more particularly a food grade emulsion capable to modulate sensory properties in foods and beverages.

The emulsion of the invention is notably characterised by the presence in its dispersed phase of at least one enzymatically modified lipid component.

The emulsion of the present invention constitutes a stable and effective flavour delivery system and can thus be incorporated as such in a food composition or a beverage composition.

### BACKGROUND OF THE INVENTION

Oil-in-water emulsions have been widely used as flavour delivery systems in the food industry, especially in the area of soft-drinks and beverages. However, their limited thermodynamic stability, which means that they always tend to separate into their two original liquid phases on standing, represents the biggest drawback in application and has the consequence that such delivery systems continuously need to be improved.

Furthermore, it is known that the presence of water presents both risks of microbiological instability and risks of hydrolysis of sensitive compounds. One solution disclosed in the prior art is the use of chemical preservatives. However, such chemically produced components nowadays are less desirable in many food applications and less appealing to consumers, compared to flavor delivery systems containing “clean label” or minimally-processed ingredients.

Last but not least, the increased demand from consumers for foods and beverages with low caloric nutrients is driving the development of new delivery systems able to either modulate sensory properties in foods and beverages, either positive (eg mouthfeel, creaminess, sweetness) or/and negative sensory stimuli (eg bitterness, astringency, sourness) depending on the objectives.

There is therefore a need for a stable emulsion that would prevent any risk of microbial spoilage and that would modulate sensory properties in foods and beverages.

### SUMMARY OF THE INVENTION

The present invention solves the above-mentioned problems by providing a stable emulsion that is capable to modulate some sensory properties (for example mouthfeel enhancement) in different food/beverage compositions and notably in fat-free and low-fat foods and beverages in which the emulsion is added.

In particular, the use of at least one enzymatically modified lipid component in the dispersed phase and the use of glycerol in the continuous phase is unexpectedly improving both the sensory properties in foods and beverages containing the emulsion and the overall physical- chemical stability of such emulsion compared to conventional oil-in-water emulsions.

A first object of the invention is therefore an emulsion comprising:
a continuous phase comprising glycerol and a first emulsifier,
a dispersed phase comprising a second emulsifier and at least one enzymatically modified lipid component.

A second object of the invention is a process for preparing the emulsion defined above, said process comprising the steps of:
i) dissolving a first emulsifier in glycerol to form a continuous phase;
ii) dissolving a second emulsifier in at least one enzymatically modified lipid component in a liquid state to form a dispersed phase ;
iii) adding the dispersed phase into the continuous phase to form a liquid mixture;
iv) emulsifying the liquid mixture of step iii) to obtain an emulsion.

A third object of the invention is an aqueous beverage composition or a food product comprising the emulsion as defined above.

A fourth object of the invention is the use of the emulsion as defined above in a flavoring consumer product for delivering sensory modulation.

### DETAILED DESCRIPTION OF THE INVENTION

Unless stated otherwise, percentages (%) are meant to designate a percentage by weight of a composition. It should be understood that the total amount of ingredients in the composition or emulsion is 100%.

The term “emulsion” refers to biphasic liquid mixtures of a dispersed phase into a continuous phase.

The term “emulsion” can cover “macroemulsions” and/or “nanoemulsions” (thermodynamically unstable mixtures) and/or microemulsions (thermodynamically stable mixtures).

According to a particular embodiment, the emulsion is a “macroemulsion” and/or a “nanoemulsion” (thermodynamically unstable mixtures). In other words, according to this particular embodiment, the emulsion is not a microemulsion (thermodynamically stable mixtures). According to an embodiment, the enzymatically modified lipid component is chosen in the group consisting of at least one enzymatically modified fat and/or at least one enzymatically modified oil.

The term “fat” used in the present invention refers to lipid components that are solid or in the form of a paste at room temperature whereas the term “oil” used in the present invention refers to lipid components that are liquid at room temperature.

By “native lipid component”, it is meant lipid component not submitted to any modification (by chemical, enzymatic, physical or microbiological means) and that contain essentially triglycerides of fatty acids. The terms “native lipid component” or “unmodified lipid component” are used indifferently in the present invention.

By “enzymatically modified lipid component”, it is meant a lipid component, preferably fat or oil, submitted to partial lipolysis by using at least one lipase, preferably under controlled reaction conditions.

After such enzymatic modifications, enzymatically modified lipid component, preferably, fats or oils are typically complex mixtures of triglycerides, di-glycerides, mono-glycerides, and the liberated free fatty acids in various ratios depending on the parameters of the enzymatic reaction(s).

The person skilled in the art will be able to select suitable reaction parameters such as the nature of the lipase or the concentration of the lipase according to the targeted enzymatically modified lipid component.

Usually such enzymatically modified lipid components, preferably fats or oils are characterized by measuring an “acidity index” (by → basic titration) that reflects the amount of free fatty acids in the final mixture after lipolysis.

A standard method to determine such a acidity index is described in “IUPAC-Standard Methods for the Analysis of Oils, Fats and Derivatives. Pergamon Press, 5″ ed., pages 52 and following (1979)”.

Emulsion

A first object of the invention is an emulsion comprising:
a continuous phase comprising glycerol and a first emulsifier,
a dispersed phase comprising a second emulsifier and at least one enzymatically modified lipid component.

Continuous phase

The continuous phase of the emulsion comprises glycerol and a first emulsifier. Glycerol used in the present invention serves as a substitution of at least one part or the totality of water in the emulsion. Furthermore, without being bound by any theory, the inventors are of the opinion that it also contributes to the modulation of sensory sensations when the emulsion is added into consumer products.

Glycerol is preferably used in an amount comprised between 50 and 99% by weight, preferably comprised between 60 and 90% by weight, based on the total weight of the emulsion.

The first emulsifier is essential to reduce the interfacial tension between the continuous and dispersed phases during the emulsion formation and is also essential to stabilize the emulsion once formed.

As non-limiting examples of emulsifiers, one may cite lecithins (E 322), polyoxyethene (40) stearate (E 431), polysorbate 20 sorbitan derivatives (polysorbates 20 E 432; polysorbate 80 E 433; polysorbate 40 E 434; polysorbate 60 E 435; polysorbate 65 E 436), mixed ammonium salts of phosphorylated glycerides (E 442), enzymically hydrolysed carboxymethylcellulose (E 469); mono- and diglycerides of fatty acids (E 471); esters of mono- and diglycerides of fatty acids like acetic acid esters (E472a), lactic acid esters (E472b), citric acid esters (E472c), tartaric acid esters (E472d), mono- and diacetyl tartaric acid esters (E472e or DATEM), mixed acetic and tartaric acid esters (E472f), succinylated monoglycerides (E472g), sucrose esters of fatty acids (E473), sucroglycerides (E474), polyglycerol esters of fatty acids(E475), polyglycerol polyricinoleate (E476 or PGPR), Propane-1,2-diol esters of fatty acids, propylene glycol esters of fatty acids (E477), lactylated fatty acid esters of glycerol and propane-1 (E478), thermally oxidized soya bean oil interacted with mono- and diglycerides of fatty acids (E479b), sodium stearoyl lactylate (E 481 or SSL), calcium stearoyl lactylate (E 482), stearyl tartrate (E 483), stearyl citrate (E 484), sodium stearoyl fumarate (E 485), calcium stearoyl fumarate (E 486), sodium dodecyl sulfate (E 487 or SDS), ethoxylated mono- and di-glycerides (E488), Methyl glucoside-coconut oil ester (E 489), sorbitans aka “Spans” like sorbitan monostearate (E 491), sorbitan tristearate (E 492), sorbitan monolaurate (E 492), sorbitan monooleate (aka E 493), sorbitan monopalmitate (E 494), sorbitan trioleate (E 496) and mixtures thereof.

The first emulsifier is preferably provided in an amount between 0.01% and 20% by weight of the total weight of the emulsion, more preferably between 0.05% and 10% by weight of the total weight of the emulsion, even more preferably between 0.10% and 5% by weight, based on the total weight of the emulsion.

Dispersed phase

The weight ratio between the dispersed phase and the continuous phase is preferably comprised between 5:95 and 50:50.

The presence of enzymatically modified lipid component in the dispersed phase is essential to the invention since it can modulate sensory properties at taste (eg sourness, sweetness, bitterness), touch and/or trigeminal level (for example mouthfeel enhancement, astringency) in particular in fat-free, low-fat foods and/or beverages in which the emulsion is added.

When the enzymatically modified lipid is an enzymatically modified fat, it is preferably chosen in the group consisting of an enzymatically modified animal fat, an enzymatically modified vegetable fat, an enzymatically modified fat obtained by fermentation or biotechnology and mixtures thereof.

When the enzymatically modified lipid is an enzymatically modified oil, it is preferably chosen in the group consisting of an enzymatically modified animal oil, an enzymatically modified vegetable oil, an enzymatically modified oil obtained by fermentation or biotechnology and mixtures thereof.

According to a particular embodiment, the dispersed phase further comprises a native lipid component (i.e non-enzymatically modified lipid component), preferably native fat and/or native oil.

The native fat is preferably chosen in the group consisting of a native animal fat, a native vegetable fat, a native fat obtained by fermentation or biotechnology and mixtures thereof.

The native oil is preferably chosen in the group consisting of a native animal oil, a native vegetable oil, a native oil obtained by fermentation or biotechnology and mixtures thereof

When a native lipid component is present in addition to the enzymatically modified lipid component, the nature of the lipid component can be the same or can differ.

When a native oil is present in addition to the enzymatically modified oil, the nature of the oil can be the same or can differ.

When a native fat is present in addition to the enzymatically modified fat, the nature of the fat can be the same or can differ.

For example, the dispersed phase can comprise an enzymatically butter fat and a corresponding native butter fat (same nature of the fat).

However, the dispersed phase can comprise an enzymatically butter fat and a corresponding native tallow fat (different nature of the fat).

According to an embodiment, the dispersed phase comprises an enzymatically modified fat and a native vegetal oil.

According to an embodiment, the dispersed phase consists of an enzymatically modified fat and a native fat, wherein the nature of the fat is the same.

According to another embodiment, the dispersed phase consists of an enzymatically modified oil and a native oil, wherein the nature of the oil is the same.

According to another embodiment, the dispersed phase comprises an enzymatically modified fat, a native fat, an enzymatically modified oil, a native fat, wherein the nature of the oil is the same and wherein the nature of the fat is the same.

According to an embodiment, the animal fat is chosen in the group consisting of butter, butter fractions, tallow, lard and mixtures thereof According to an embodiment, the vegetable oil is chosen in the group consisting of oils produced from vegetable sources like sunflower, rapeseed/canola, soybean, palm, coconut, groundnut (peanut), palm kernel, olive, cottonseed, sesame, lineseed and mixtures thereof.

The second emulsifier may be used in an amount comprised between 0.01% to 10%, more preferably from 0.05% to 5%, even more preferably from 0.10% to 0.5% by weight based on the total weight of the emulsion.

The dispersed phase of the invention may comprise a lecithin as a complementary emulsifier (second emulsifier) to the first emulsifier present in the continuous phase.

Without being bound by any theory, the inventors believe that lecithin contributes to the reduction of average droplet in the emulsion itself, which is beneficial for the long term physical- chemical stability of the emulsion. Secondly, lecithin allows to maintain the stability of emulsion after addition of emulsion into a low viscosity acidic mixture. The emulsion of the invention is therefore stable in low viscosity acidic mixtures (e.g acid milk drinks; yogurt drinks; juice drinks; acidic beverages; savoury dressings).

According to the invention, lecithins (mixtures of glycerophospholipids including phosphatidylcholine PC, phosphatidylethanolamine PE, phosphatidylinositol PI, and phosphatidic acid PA) with different triglyceride content (pure lecithins or deoiled lecithins, different ratio PC-to-PE-to-PI) and in the form of oily paste or powders can be used. Lecithins are commercially available from a number of suppliers including Cargill (brands Emulpur™, Emultop™, Lecimulthin™, Epikuron™), Archer Daniels Midland (brand Ultralec®, Adlec™), Solae (brand)Solec®, Bunge (brand BungeMaxx™).

Lecithin is preferably provided in an amount from 0.01% to 10%, more preferably from 0.05% to 5%, even more preferably from 0.10% to 0.5% by weight based on the total weight of the emulsion. According to an embodiment, the emulsion of the invention is free of chemical preservatives. As non-limiting examples of chemical preservatives, one can cite sorbates (eg sodium sorbate E 201, benzoates (eg potassium sorbate E212), sulfites (eg sodium bisulfite E222), phenols (eg orthophenyl phenol E231), formates (eg sodium formate E237), acetates (eg sodium acetate E262) or propionates (eg potassium propionate E283).

The droplet sizes of the dispersed phase for emulsions described in the present invention are in the range 0.1 to 1000 micrometer with an average droplet size preferably in the range 0.2 to 500 micrometer.

Optional ingredients

Co-solvents: The continuous phase can comprise one or several co-solvents to adjust the viscosity of the emulsion, preferably chosen in the group consisting of water, propylene glycol and mixtures thereof. It was found that low amounts of water or propylene glycol (in the range 5 to 20%) are able to reduce viscosity of final emulsion below 2000mPa.s, preferably 1000 mPa.s still maintaining a very low water activity (aw <0.50), thus ensuring a total microbiological stability of the emulsion .

When present, propylene glycol is preferably added up to 20%, preferably between 5% and 20% by weight based on the total weight of the emulsion.

When present, water is preferably added up to 20%, preferably added up to 15%, preferably between 5% and 20% by weight based on the total weight of the emulsion.

According to a particular embodiment, the emulsion is free from water.

Flavor composition: The emulsion of the invention can comprise a flavor composition in the continuous phase and/or in the dispersed phase according to the polarity of the flavor. Preferably, the flavor is present in an amount comprised between 0.05 and 10, preferably between 0.5 and 5% by weight based on the total weight of the emulsion.

By “flavor or flavoring composition,” it is meant here a flavoring ingredient or a mixture of flavoring ingredients, solvents or adjuvants used or the preparation of a flavoring formulation, i.e. a particular mixture of ingredients which is intended to be added to an edible composition (including but not limited to a beverage) or chewable product to impart, improve or modify its organoleptic properties, in particular its flavor and/or taste. Flavoring ingredients are well known to a person skilled in the art and their nature does not warrant a detailed description here, which in any case would not be exhaustive, the skilled flavorist being able to select them on the basis of his or her general knowledge and according to the intended use or application and the organoleptic effect it is desired to achieve. Many of these flavoring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, van Nostrand Co., Inc. Solvents and adjuvants of current use for the preparation of a flavoring formulation are also well known in the industry.

Process for preparing the emulsion

Another object of the invention is a process for preparing the emulsion defined above, said process comprising the steps of:

i) dissolving a first emulsifier in glycerol to form a continuous phase;

ii) dissolving a second emulsifier in at least one enzymatically modified lipid component in a liquid state to form a dispersed phase;

iii) adding the dispersed phase into the continuous phase to form a liquid mixture; and

iv) emulsifying the liquid mixture of step iii) to obtain an emulsion.

All components of the emulsion are as defined above.

To reduce the viscosity of glycerol and allow to solubilize the emulsifier more easily, glycerol is preferably heated at a temperature comprised between 30 and 80° C., preferably between 40 and 70° C.

When one or several co-solvents as defined previously are present, they are added in step i) with glycerol.

In step ii), to prepare the dispersed phase, working temperature needs to be above final melting temperature of the lipid component (fatty or oily components) in order to ensure a liquid-in- liquid pre-emulsification. Depending on the nature of the fat and/or oil, the skilled person in the art will be able to select a suitable temperature for carrying out step ii) to obtain a mixture in a liquid state.

When a flavour composition as defined above is present, it is added in the dispersed phase or in the continuous phase or added during the emulsification step.

The emulsion can be formed using any known emulsifying method, such as high shear mixing, sonication or homogenization and mixtures thereof. Such emulsifying methods are well known to the person skilled in the art.

Consumer product

The emulsion of the invention can be used in a great variety of edible end products. Consumer products may include food compositions or beverages compositions. For example foodstuff base that could use the powdered microcapsules of the invention include
Baked goods (e.g. bread, dry biscuits, cakes, other baked goods),
Non-alcoholic beverages (e.g. carbonated soft drinks, bottled waters , sports/energy drinks , juice drinks, vegetable juices, vegetable juice preparations),
Alcoholic beverages (e.g. beer and malt beverages, spirituous beverages),
Instant beverages (e.g. instant vegetable drinks, powdered soft drinks, instant coffee and tea),
Cereal products (e.g. breakfast cereals, pre-cooked ready-made rice products, rice flour products, millet and sorghum products, raw or pre-cooked noodles and pasta products),
Milk products (e.g. fresh cheese, soft cheese, hard cheese, milk drinks, whey, butter, partially or wholly hydrolysed milk protein-containing products, fermented milk products, condensed milk and analogues),
Dairy based products (e.g. fruit or flavored yoghurt, ice cream, fruit ices, frozen desserts)
Dairy analogues (imitation dairy products) containing non-dairy ingredients (plant-based proteins, vegetable fats),
Confectionary products (e.g. chewing gum, hard and soft candy),
Chocolate and compound coatings,
Products based on fat and oil or emulsions thereof (e.g. mayonnaise, spreads, margarines, shortenings, remoulade, dressings, spice preparations),
Spiced, marinated or processed fish products (e.g. fish sausage, surimi),
Eggs or egg products (dried egg, egg white, egg yolk, custard),
Desserts (e.g. gelatins and puddings),
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchup, sauces, processed and reconstituted vegetables, dried vegetables, deep frozen vegetables, pre-cooked vegetables, vegetables pickled in vinegar, vegetable concentrates or pastes, cooked vegetables, potato preparations),
Vegetarian meat analogues or meat replacers, vegetarian burger
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts),
Meat products (e.g. processed meat, poultry, beef, pork, ham, fresh sausage or raw meat preparations, spiced or marinated fresh meat or cured meat products, reformed meat),
Ready dishes (e.g. instant noodles, rice, pasta, pizza, tortillas, wraps) and soups and broths (e.g. stock, savory cube, dried soups, instant soups, pre-cooked soups, retorted soups), sauces (instant sauces, dried sauces, ready-made sauces, gravies, sweet sauces).

Preferably, the emulsion according to the invention shall be used, preferably in amount comprised between 0.01% and 10% by weight, in products selected from the group consisting of baked goods, instant beverages, cereal products, milk products, dairy-based products, products based on fat and oil or emulsions thereof, desserts, vegetable preparations, vegetarian meat replacer, spices and seasonings, snacks, meat products, ready dishes, soups and broths and sauces.

The emulsion defined in the present invention is capable to modulate some sensory properties especially in fat-free and low-fat foods and beverages in which the emulsion is added.

Thus, according to a particular embodiment, the consumer product is a fat-free and low- fat foods and beverages.

A last object of the invention is the use of the emulsion as defined above in a flavoring consumer product for delivering sensory modulation.

By “Sensory modulation”, it covers different kind of sensations like touch sensations (mouthfeel enhancement; mouth coating enhancement) and/or taste sensations (sourness/acidity) and/or aroma sensations.

### Examples

The invention will now be described in further detail by way of the following examples.

Example 1 Preparation of emulsions

Process for preparing the enzymatically modified fat and/or oil In a 500 ml flask there were mixed 100 g of fat or oil, 50 g of demineralized water and 1 g of enzyme of type Lipomod.RTM. 29 (lipase; origin: Biocatalysts Ltd., Great Britain). The mixture was well homogenized and stirred for 17 h at 40° -45° . The temperature was increased to 90- 95° C. and the mixture stirred during 15 min. The oily and aqueous layers were then separated by centrifuging. The oily phase was diluted with 1 part of Neobee M 5 (triglyceride of capric/caprylic acid; origin: PVO Int. Inc., N.Y., USA) and the solution was partially deodorized by distilling twice through a distillation apparatus of the Leybold type (“flash-distillation”) at 60° C. and 80° C. and a pressure of 13 Pa.

The thus obtained enzymatically modified oil(s) are used in the emulsions described further on.

Process for preparing emulsions of the invention 1 - Preparation of the dispersed phase: Weight in glass becher fatty/oily compounds. Melt separately fatty/oily compounds (water-bath 40° C.). Mix melted fatty/oily compounds altogether. Add lecithin and vitamin E. Keep oil phase mixture in melted liquid state (approx 40° c) before pre-emulsification (water-bath 40° C.).

2- Preparation of the continuous phase: Weight glycerol in glass becher and Preheat glycerol at 40° C. (heating plate, IKA helix, speed 7). Dissolve citric ester of mono- and diglycerides (heating plate - IKA helix - speed 5 to minimise foam formation - 15 minutes). Add a co-solvent (propylene glycol) into the solvent phase and mix well until a homogeneous solution is obtained.

3 - Preparation of the emulsion:

3.1 Pre-emulsification at 40° C.: add and mix dispersed phase (40° C.) into continuous phase (40° C.) with efficient stirring (lab scale conditions: Ultra-Turax T50, Emulsion tool S50N-G40S, speed 3, 5 min) 3.2 Homogenisation high-pressure: 40° C. - homogenizer APV Lab 1000: 1 pass 300 bar (250 bar 1st stage / 50 bar 2nd stage)

TABLE 1
Emulsion compositions

| | Function | Sample A |
|---|---|---|
| Ingredient | | wt % |
| Continuous phase | | |
| Glycerol | Solvent | 63.18 |
| Propylene Glycol | Co-solvent | 20 |
| Citric ester of mono | First emulsifier | 0.6 |
| and di-glycerides | | |
| Dispersed phase | | |
| Sunflower Oil | Native oil | 8 |
| Sunflower oil | Enzymatically | 8 |
| enzymatically | modified oil | |
| modified | | |
| Vitamin E | | 0.02 |
| Sunflower Lecithin | Second emulsifier | 0.2 |
| Total | | 100 |
| Aspect emulsion | | light yellow |
| Physical-chemistry | | |
| Viscosity(mPa · s at | | 1200-1300 |
| 100s−1-room | | |
| temperature | | |
| Fat droplet sizing | | |
| Before | | |
| homogenisation | | |
| Size curve type | | Monomodal |
| D(3/2) micrometer | | 0.55 |
| After homogenisation | | |
| Size curve type | | Monomodal |
| D(3/2) micrometer | | 0.45 |

1- Preparation of the dispersed phase: Melt separately fatty materials (water-bath 50° C.). Mix melted fatty materials together and keep mixture in melted liquid state (approx 45-50° C.) before the emulsification

2- Preparation of the continuous phase: Premix glycerol at 70° C. (heating plate, IKA helix, speed 7) and dissolve Sucrose Ester (heating plate - IKA helix - speed 5 to minimise foam formation - 15 minutes)

3- Preparation of the oil-in-glycerine emulsion:

3.1 Pre-emulsification at 60° C.: add and mix dispersed phase (45-50° C.) into continuous phase (65-70° C.) with efficient stirring (lab scale conditions: Ultra-Turax T50, Emulsion tool S50N- G40S, speed 3, 5 min) Avoid foam / air formation

For sample D: Add liquid flavor during preemulsification (Ultra-Turrax-Emulsion tool S50N- G40S-speed 1 - 5 min)

3.2 Homogenisation high-pressure: lab scale conditions: 50° C. - homogenizer APV Lab 1000 : 1 pass 300 bar (250 bar for 1^{st} stage / 50 bar 2^{nd} stage)

TABLE 2
Emulsion compositions

| | | Sample | Sample | Sample |
|---|---|---|---|---|
| | | B | C | D |
| Ingredient | Function | wt % | wt % | wt % |
| Glycerol | Solvent | 83.38 | 63.48 | 81.48 |
| Propylene | Co-solvent | | 20 | |
| Glycol | | | | |
| Water | | | | |
| deionized | | | | |
| Sucrose Ester | First | 0.4 | 0.4 | 0.4 |
| | emulsifier | | | |
| Butter fat | Native dairy | | 4 | |
| unmodified | fat | | | |
| Butter fat | Enzymatically | | 4 | |
| enzymatically | modified | | | |
| modified | dairy fat | | | |
| Sunflower Oil | Native oil | 8 | 4 | 8 |
| Sunflower oil | Enzymatically | 8 | 4 | 8 |
| enzymatically | modified oil | | | |
| modified | | | | |
| Vitamin E | | 0.02 | 0.02 | 0.02 |
| Sunflower | Second | 0.2 | 0.1 | 0.1 |
| Lecithin | emulsifier | | | |
| Cream aroma | Flavor | | | 2 |
| | composition | | | |
| Total | | 100 | 100 | 100 |
| Aspect | | Opaque | Clear | Opaque |
| emulsion | | | | |
| Physical- | | | | |
| chemistry | | | | |
| Viscosity | | 2700 | 1260 | 3140 |
| ((mPa · | | | | |
| s á 10s−1) | | | | |
| Fat droplet | | | | |
| sizing | | | | |
| Size curve | | Mono- | Mono- | Mono- |
| type | | modal | modal | modal |
| D(3/2) | | 0.3 | 0.42 | 0.46 |
| micrometer | | | | |
| D(V-0.9) | | 0.71 | 1.24 | 1.29 |
| micrometer | | | | |
| D(V-0.1) | | 0.17 | 0.2 | 0.25 |
| micrometer | | | | |

Example 2

Performance of the emulsion of the invention in a dairy product

Eight to twelve trained expert panelists were asked to rate the intensity of various sensory descriptors using a 0 to 5 structured scale (from 0 ‘not perceptible’ to 5 ‘strong intensity’) in a yogurt or milk (CONTROL) and in a yogurt comprising the emulsion of the invention. Sensory descriptors were selected to assess taste, tactile and aromatic stimuli with (1) two taste descriptors (‘Sweet’, ‘Acidic’), three mouthfeel' descriptors (‘Thick’, ‘Mouth coating’, ‘Fatty’) and two aromatic descriptors (‘Creamy’, ‘Yoghurt’). Product presentation was blind and randomized. Data treatment was run with XLSTAT software.

TABLE 3
intensity rating scores and statistical parameters for
fat-free stirred sweet yogurt (5% added sucrose)

| | Control | Sample D | F Calc. | Proba. |
|---|---|---|---|---|
| Sweet | 2.81 | 2.69 | 0.18 | 0.6845 |
| Acidic | 3.19 A | 2.56 B | 5.65 | 0.0492* |
| Thick | 2.81 | 3.38 | 3.40 | 0.1079 |
| Mouthcoating | 2.88 | 3 | 0.08 | 0.7895 |
| Fatty | 2.44 | 2.81 | 0.76 | 0.4125 |
| Creamy | 2.62 | 3.25 | 2.97 | 0.1287 |
| Yoghurt | 3.5 | 3.62 | 0.18 | 0.6845 |

One can conclude for these results that:
Addition of emulsion of the present invention (sample D) (0.08%) in fat —free stirred yogurt led to a significant “sourness/acidity” reduction
Descriptors “Thick” and “Creamy” are directionally increased (close to 10% statistical significance) as well as “fatty” and “yogurt” character.

TABLE 4
Intensity rating scores and statistical parameters in
very low-fat stirred yogurt (0.5% fat-5% added sucrose)

| | Control | Sample D | F Calc. | Proba. |
|---|---|---|---|---|
| Sweet | 2.71 | 3 | 2.40 | 0.1723 |
| Acidic | 2.64 | 2.07 | 2.40 | 0.1723 |
| Thick | 3.21 | 3.5 | 1.00 | 0.3559 |
| Mouthcoating | 3.14 | 3.5 | 0.84 | 0.3940 |
| Fatty | 3.21 | 3.5 | 1.17 | 0.3208 |
| Creamy | 2.79 B | 3.57 A | 6.60 | 0.0424* |
| Yoghurt | 3.57 | 3.5 | 1.00 | 0.3559 |

One can conclude from these results that:
Adding emulsion of the present invention (sample D) (0.08%) led to a significant “creamy” enhancement
Taste descriptors “Sweet” and “Acidic” are directionally increased and reduced respectively (close to statistical significance): the decrease in “acidic” perception confirms same observation in fat-free yogurt
Three tactile attributes “Thick, “mouthcoating”, “fatty” are directionally increased.

TABLE 5
sensory rating scores and statistical parameters
fat-free diluted sweet UHT milk (20%
water-5% added sucrose)

| | Control | Sample D | F Calc. | Proba. |
|---|---|---|---|---|
| Sweet | 3.81 | 3.56 | 1.00 | 0.3506 |
| Mouthcoating | 2.37 B | 2.94 A | 10.31 | 0.0148* |
| Thick | 2.38 | 2.5 | 0.18 | 0.6845 |
| Fatty | 2.56 | 2.81 | 1.00 | 0.3506 |
| Creamy | 2.37 | 2.94 | 2.30 | 0.1735 |
| Milky | 2.81 | 2.69 | 1.00 | 0.3506 |

One can conclude from these results that:
Adding emulsion of the present invention (sample D) (0.08%) led to a significant “mouthcoating” enhancement
Two other tactile attributes “Thick” and “fatty” and “creamy” are directionally increased upon addition of sample D (0.08%)

Key points from sensory assessment of emulsion sample D in three types of dairy matrices are the following:
For the two fat-free dairy matrices (stirred yogurt and UHT milk), adding anhydrous flavored emulsion (sample D—dosage 0.08%) allowed to trigger significant preference.
“Mouthcoating” is increased in the three tested matrices, with statistical significance in low viscosity matrix (fat-free diluted sweet UHT milk)
“Acidity/sourness” is reduced in both types of yogurt (significant in fat-free) thus suggesting “sourness masking” properties.

1. An emulsion comprising:
a continuous phase comprising glycerol and a first emulsifier, and
a dispersed phase comprising a second emulsifier and at least one enzymatically modified lipid component.

2. The emulsion according to claim 1, wherein the enzymatically modified lipid component is selected from the group consisting of at least one enzymatically modified fat and at least one enzymatically modified oil.

3. The emulsion according to claim 1, wherein the glycerol is used in an amount comprised between 50 and 99% by weight based on the total weight of the emulsion.

4. The emulsion according to claim 1, wherein a weight ratio between the dispersed phase and the continuous phase is comprised between 5:95 and 50:50.

5. The emulsion according to claim 1, wherein the continuous phase comprises a co-solvent selected from the group consisting of water, propylene glycol and mixtures thereof.

6. The emulsion according to claim 1, wherein the emulsion comprises up to 15% by weight of water based on the total weight of the emulsion.

7. The emulsion according to claim 1, wherein the dispersed phase further comprises at least a native lipid component.

8. The emulsion according to claim 2, wherein the fat is selected from the group consisting of butter, butter fractions, tallow, lard and mixtures thereof and wherein the oil is selected from the group consisting of sunflower oil, canola oil, soy oil, palm oil, coconut oil and mixtures thereof.

9. The emulsion according to claim 1, wherein the dispersed phase comprises an enzymatically modified fat and a native fat, wherein the nature of the fat is the same and/or comprises an enzymatically modified oil and a native oil, wherein the nature of the oil is the same.

10. The emulsion according to claim 1, wherein the first emulsifier is selected from the group consisting of citric ester of mono-and di-glycerides, sucrose ester, saponins, and mixtures thereof.

11. The emulsion according to claim 1, wherein the second emulsifier is a lecithin.

12. The emulsion according to claim 1, wherein the enzymatically modified lipid component is provided in an amount between 1% to 50% by weight of the total weight of the emulsion.

13. The emulsion according to claim 1, wherein the emulsion comprises a flavoring composition.

14. A process for preparing an emulsion, said process comprising the steps of:
dissolving a first emulsifier in glycerol to form a continuous phase;
(ii) dissolving a second emulsifier in at least one enzymatically modified lipid component in a liquid state to form a dispersed phase;
(iii) adding the dispersed phase into the continuous phase to form a liquid mixture;
and (iv) emulsifying the liquid mixture of step iii) to obtain an emulsion.

15. A food or beverage consumer product comprising the emulsion as defined in claim 1, said consumer product being selected from the group consisting of baked goods, instant beverages, cereal products, milk products, dairy-based products, products based on fat and oil or emulsions thereof, desserts, vegetable preparations, vegetarian meat replacer, spices and seasonings, snacks, meat products, ready dishes, soups and broths and sauces.

16. The emulsion according to claim 1, wherein the second emulsifier is a lecithin used in an amount comprised between 0.01 and 10% by weight based on the total weight of the emulsion.

17. The emulsion according to claim 1, wherein the enzymatically modified lipid component is provided in an amount between 5% to 40% by weight of the total weight of the emulsion or between 10% to 30% by weight of the total weight of the emulsion.

18. The emulsion according to claim 7, wherein the enzymatically modified lipid component with the native lipid component are provided in an amount between 1% to 50% by weight of the total weight of the emulsion.

19. The emulsion according to claim 7, wherein the enzymatically modified lipid component with the native lipid component are provided in an amount between 5% to 40% by weight of the total weight of the emulsion or between 10% to 30% by weight of the total weight of the emulsion.
